(19) United States
(12) Patent Application Publication
(10) Pub. No.: US 2012/0070545 A1
(43) Pub. Date: Mar. 22, 2012

(54) OXYGEN SCAVENGING DENDRIMERS

(75) Inventors: Ling Hu, Westlake, OH (US); Roger W. Avakian, Solon, OH (US)

(73) Assignee: POLYONE CORPORATION, Avon Lake, OH (US)

(21) Appl. No.: 13/321,497

(22) PCT Filed: May 17, 2010
(86) PCT No.: PCT/US10/35111

§ 371 Date: Nov. 18, 2011

Related U.S. Application Data
(60) Provisional application No. 61/179,296, filed on May 18, 2009.

(51) Int. Cl. B65D 85/72; B32B 1/08; C08K 3/34; C08K 5/101; C08L 67/00; C08K 3/22

(52) U.S. Cl. 426/106; 524/275; 521/88; 428/35.7

(57) ABSTRACT

A method and system for oxygen molecule scavenging is disclosed. The system employs as an amphiphilic dendritic polymer as the reducing agent for oxygen molecules in a thermoplastic compound. Clarity of the compound, nearly the same as thermoplastic matrix itself in the compound, is achieved by the addition of an epoxy-functional styrene-acrylate oligomer. Food and beverage containers now made of polyethylene terephthalate can be molded from the compound and have substantially the same haze as the polyethylene terephthalate itself but with the oxygen scavenger to maintain freshness of the food or beverage from oxidation.

### CLAIM OF PRIORITY

This application claims priority from U.S. Provisional Patent Application Ser. No. 61/179,296 bearing Attorney Docket Number 12009005 and filed on May 18, 2009, which is incorporated by reference.

### FIELD OF THE INVENTION

This invention relates to use of dendrimers, functioning as reducing agents, also known as anti-oxidants, to scavenge for oxygen within containers and packaging made from thermoplastic compounds.

### BACKGROUND OF THE INVENTION

Spoilage of food has plagued humanity for millennia. Containers for food have evolved from stone to ceramic to metallic to glass to plastic, particularly for single serving consumable foods and beverages.

Shelf life of foods and beverages is affected by oxidation from oxygen molecules within the volume of the container not occupied by the food or beverage (“headspace oxygen”), within the bulk of the container walls or closure (“inherent oxygen”), and permeating through the container walls (“permeated oxygen”). Also the food or beverage itself contains oxygen which equilibrates in the headspace.

Compounds that scavenge for oxygen molecules are known but are not sufficient to deal with each source of oxygen molecules because the timing of when each source of oxygen can affect the food or beverage.

Others have tried to use dendritic polymers to scavenge for oxygen, such as that disclosed in PCT Patent Publication WO/2009/029479 (Joslin et al.).

### SUMMARY OF THE INVENTION

What the art needs is a system for scavenging for oxygen molecules within thermoplastic compounds, preferably after the compounds are formed into plastic articles and especially for those compounds which are permeable to oxygen. The art especially needs a system for scavenging for oxygen which does not contribute unacceptable haze to thermoplastic compounds which are selected because of their clarity.

One aspect of the invention is a method for scavenging for oxygen within a thermoplastic article, comprising: (a) mixing a reducing agent for oxygen molecules and an epoxy-functional styrene-acrylate oligomer into a thermoplastic polymer matrix to form a thermoplastic compound and (b) forming an article from the thermoplastic compound, wherein the reducing agent is an amphiphilic dendritic polymer having carbon-carbon double bonds susceptible to reaction with oxygen molecules, and wherein the thermoplastic compound has substantially the same percentage haze value as the thermoplastic matrix.

In this invention, “substantially the same percentage haze value” means the differential of haze of the thermoplastic compound vs. haze of the thermoplastic matrix is not more than 12. Desirably, the differential is not more than 8. Preferably, the differential is not more than 4. Most preferably, the differential is not more than 2. Because haze is a value expressed in percentage, the differential is a dimensionless number.

Another aspect of the invention is a thermoplastic compound, comprising: (a) a thermoplastic polymer matrix; (b) an amphiphilic dendritic polymer functioning as a reducing agent for oxygen molecules; and (c) epoxy-functional styrene-acrylate oligomer.

Another aspect of the invention is a thermoplastic article, comprising the thermoplastic compound identified above, such as a bottle pre-form, a blow-molded bottle, or a bottle containing a perishable food or beverage susceptible to oxidation.

### EMBODIMENTS OF THE INVENTION

Thermoplastic Matrix of the Plastic Article

Any thermoplastic can be a candidate forming into a plastic article. While principally the invention serves the perishable food and beverage industry, plastic articles made from the thermoplastic compounds of the present invention can also be used in any industrial or consumer industry which needs to minimize the presence of oxygen because of its corrosive effects. For example, the electronics industry may have a need to limit the presence of oxygen in an enclosed space to minimize oxidation of expensive metals on electronic components within that enclosed space.

Mostly however, the plastic articles are intended to serve as packaging for perishable food or beverage. The ultimate plastic packaging article into which the thermoplastic matrix is formed by molding, extruding, calendering, etc. and what that ultimate article might contain or protect determine the suitability of use of that thermoplastic in the present invention.

Non-limiting examples of thermoplastics used in the food and beverage industries are polyesters (including polylactides and polyhydroxyalkanoates), polyamides, polyolefins, polycarbonates, polystyrenes, polyacrylates, thermoplastic elastomers (including thermoplastic vulcanizates) of all types, and the like.

Because the shelf-life of consumable foods and beverages needs protection from the oxidizing effect of reactions with oxygen molecules within or penetrating the containers for such foods and beverages, the selection of the thermoplastic to be used in the present invention is predicated on packaging cost, appearance, and other packaging considerations.

Of the polymeric candidates, polyesters and polyethylene are preferred as packaging materials. Of them, polyesters, particularly polyethylene terephthalate (PET) is used as plastic beverage containers of both carbonated and non-carbonated consumables. Additionally, thermoplastic elastomers are preferred for use as closures or closure liners or gaskets or seals with the packaging materials such as a plastic beverage container.

Reducing Agent for Oxygen Molecules

Once the thermoplastic matrix is selected for the packaging, then the reducing agent for oxygen molecules can be selected. The reducing agent for the present invention is a dendritic polymer commercially used and advertised as an architectural, water-borne coating and marketed by Perstorp AB as Boltorn W3000 brand amphiphilic, air-drying dendritic polymer. A “dendritic polymer” is also known in the polymer industry as a “dendrimer.”

Boltorn W3000 is a yellow wax currently useful as a dispersing resin to disperse non-amphiphilic conventional resins and pigments in an aqueous media, to allow for the formulation of volatile organic chemical-free and surfactant-free waterborne coatings. The yellow wax is advertised to exhibit very good compatibility with a large number of alkyds, polyesters and pigments resulting in high gloss and durable coatings.

The amphiphilic dendritic polymer has a weight average molecular weight of about 9,000 g/mol as measured using Gel Permeation Chromatography (GPC), a viscosity of about 15,000 mPas as measured at 23° C. and 30^{s-1}, and a fully aliphatic oil length of 45% calculated as triglyceride. Its acid number is a maximum of 10 mg of KOH/g. Its water content is about 4-6%.

Product literature for Boltorn W3000 dendrimer depicts the morphology of the dendrimer as having a dendritic backbone about 1 nm in diameter from which extend both hydrophobic chains and hydrophilic chains, creating the amphiphilic nature of the polymer. The length of the hydrophilic chains ranges from about 0.1 to about 1 nm, whereas the length of the hydrophobic chains range from about 2 to about 5 nm.

The hydrophobic chains are long unsaturated fatty acid chains and contain carbon-carbon double bonds which have been found to be are susceptible to oxidation by oxygen molecules.

More specifically, as reported by its manufacturer, Boltorn® W3000 dendritic polymer is a non-ionic, self-emulsifying amphiphilic dendritic polymer, consisting of a dendritic globular structure from which chain ends are terminated by a combination of hydrophobic chains (long unsaturated fatty acid allowing air drying oxidation process) and hydrophilic chains (methyl polyethylene glycol chains). The amphiphilic nature of this dendritic polymer confers some dispersing and stabilizing properties. This behavior is used to disperse conventional alkyd resins (initially prepared for solvent borne systems) in water. A core/shell particle type of emulsion is obtained, the core being the alkyd resin that controls the coating properties and the shell being the amphiphilic dendritic polymer. BOLTORN® W3000 which performs as a stabilizer/emulsification agent allowing surfactant free or almost surfactant.

The usefulness of this dendrimer is its locations of unsaturation on the hydrophobic chains.

As further reported by its manufacturer, this amphiphilic dendritic polymer is made from a pentaerythritol derivative which still has 4 alcohols able to build layers with dimethylproprionic acid (DMPA) and get the hyperbranched polyester morphology (i.e., its dendrimer structure) which then is functionalized, followed by being capped with methyl polyethylene glycol (MPEG) and some hydrophobic sunflower fatty acid.

The dendrimer is macromolecular and not susceptible to migration or “blooming,” especially because of its amphiphilic nature.

The dendrimer is particularly advantageous in use as a reducing agent for oxygen molecules is because its dendritic structure makes many unsaturated carbon-carbon bonds available for oxidation, per unit volume of dendrimer. These unsaturated carbon-carbon bonds are vulnerable to oxidation by free oxygen molecules which come into contact with them, whether within the bulk of the plastic packaging article wall or on the surface of that wall. In effect, this vulnerability becomes the reducing agent of the macromolecular dendrimer and each oxygen molecule—carbon-carbon double bond reaction is a scavenging event for mobile oxygen molecules within a food or beverage container or package made using the dendrimers

Oligomer

The compound also benefits from the addition of an epoxy-functional styrene-acrylate oligomer for the purpose of providing compatibility between the thermoplastic matrix and the dendrimer to reduce haze in plastic articles molded from such three-ingredient compounds.

One such oligomer is marketed by BASF Corporation as Joncryl™ brand chain extender.

Additional information about the epoxy functional low molecular weight styrene-acrylate copolymer is disclosed in U.S. Pat. No. 6,605,681 (Villalobos et al.) and U.S. Pat. No. 6,984,694 (Blasius et al.), incorporated by reference herein.

Stated another way, the oligomeric chain extender is the polymerization product of (i) at least one epoxy-functional (meth)acrylic monomer; and (ii) at least one styrenic and/or (meth)acrylic monomer, wherein the polymerization product has an epoxy equivalent weight of from about 180 to about 2800, a number-average epoxy functionality (Efn) value of less than about 30, a weight-average epoxy functionality (Efw) value of up to about 140, and a number-average molecular weight (Mn) value of less than 6000. Preferably, the oligomeric chain extender a polydispersity index of from about 1.5 to about 5.

Various Joncryl™ grades available and useful from BASF are ADR-4300, ADR-4370-S, ADR-4368-F, and ADR-4368-C, which are all solids. Alternatively, one can use liquid grades, namely: ADR-4380, ADR-4385, and ADR-4318.

Particularly preferred is Joncryl™ ADR-4368-C grade. The number average molecular weight of this grade is less than 3000 with approximately 4 epoxy functionalities per polymer chain.

Formula I shows the epoxy-functional styrene-acrylate polymer, wherein R₁-R₅ can be H, CH₃, a higher alkyl group having from 2 to 10 carbon atoms, or combinations thereof; and R₆ can be an alkyl group; and wherein x, y, and z each can be between 1 and 20.

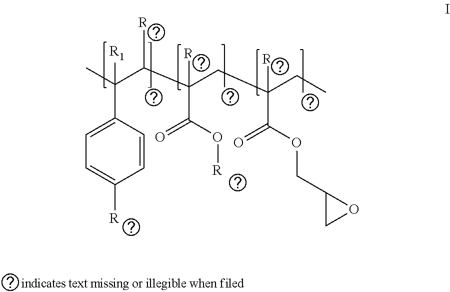

Optional Oxidation Catalyst for Reducing Agent

Catalysts can help activate the hydrophobic chains of the dendrimer. Catalysts are not required though they are preferred. Dendrimers of the invention can proceed in the scavenging for oxygen without the need for catalysis. For example, packaging which is formed at or near the same time as the filling of that packaging with food or beverage can benefit from such oxygen scavenging agents that do not need activation to begin reducing oxygen molecules.

However, for one particular industry, it is quite important for the dendrimer, functioning as the reducing agent for oxygen molecules, to remain dormant until package or container formation. Beverage bottles and other liquid containers are often made in two steps, one to form a so-called “pre-form” which has the final dimensions of the opening but is collapsed with respect to the final volume; and the second to mold the pre-form into a container, vessel, or bottle of final dimensions. For example, water, soft drink, and beer bottles start as pre-forms with the proper dimensions of the screw cap mouth and a highly collapsed remainder resembling a truncated test tube. At the bottling factory, the pre-forms are expanded by blow molding to form liter or half liter bottles just prior to beverage filling.

The dormancy of the oxygen scavenging function of the dendrimer is important for the beverage industry because one does not want to waste the oxygen scavenging properties on a pre-form exposed to the environment during storage, prior to blow molding and filling. Therefore, for this industry in particular, and any other which relies on pre-forms, such as the health care or cosmetics industries, the onset of oxygen scavenging needs to be triggered by an event after the formation of the pre-form.

Non-limiting examples of catalysts which are thermally activated include salts of cobalt, cerium, manganese, and other transition metal catalysts, etc. These types of catalysts are suitable for activation of the dendrimer to function as a macromolecular oxygen reducing agent at the time of formation of the pre-form into a blow-molded bottle, which happens at elevated heat to melt the pre-form for ultimate shaping.

A non-limiting example of a commercially available catalyst is cobalt stearate (CAS #13586-84-0) to serve as a catalyst for the oxidation of the oxidizable organic compounds. The oxygen molecule, O₂, is the most oxidizable of organic compounds.

Other Optional Additives

The plastic article used as food or beverage packaging can include conventional plastics additives in an amount that is sufficient to obtain a desired processing or performance property for the thermoplastic compound comprising the thermoplastic matrix, the reducing agent for oxygen molecules, and optionally the reducing agent catalyst. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

Table 1 shows the relative weight percents of acceptable, desirable, and preferred ingredients for compounds of the present invention.

TABLE 1
Formulation Parameters

| Weight Percents | | | |
|---|---|---|---|
| (except as noted) | Acceptable | Desirable | Preferred |
| Thermoplastic Matrix | 84-99% | 89-97% | 94-99 |
| Reducing Agent for | 0.1-3% | 0.1-2% | 0.5-1.5% |
| Oxygen Molecules | | | |
| (Dendrimer) | | | |
| Oligomer | 0.1-3% | 0.1-2% | 0.1-1% |
| Optional Oxidation | 5-1000 ppm | 5-200 ppm | 5-50 ppm |
| Catalyst for Reducing | | | |
| Agent, parts per million | | | |
| Other Optional Additives | 0-15% | 0-10% | 0-5% |

Processing of the Compound

The preparation of compounds of the present invention is uncomplicated. The compound of the present can be made in batch or continuous operations.

Mixing in a continuous process typically occurs in an extruder that is elevated to a temperature that is sufficient to melt the polymer matrix with addition either at the head of the extruder or downstream in the extruder of the solid ingredient additives. Extruder speeds can range from about 50 to about 500 revolutions per minute (rpm), and preferably from about 100 to about 300 rpm. Typically, the output from the extruder is pelletized for later extrusion or molding into plastic packaging articles such as pre-forms for plastic beverage bottles.

Mixing in a batch process typically occurs in a Banbury mixer that is also elevated to a temperature that is sufficient to melt the polymer matrix to permit addition of the solid ingredient additives. The mixing speeds range from 60 to 1000 rpm and temperature of mixing can be ambient. Also, the output from the mixer is chopped into smaller sizes for later extrusion or molding into the same types of plastic packaging articles.

The dendrimer can be mixed into the thermoplastic matrix alone, but it preferably benefits from the use of a second catalyst, one that assists the reduction reaction with oxygen.

Indeed, when a catalyst is to be used, it is preferable for the catalyst to be pre-mixed into the thermoplastic matrix before compounding with the dendrimer.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

Injection molding techniques are used to make the pre-forms mentioned above. Blow molding techniques are then used to make the fully formed plastic beverage bottle before filling with carbonated or non-carbonated beverage.

### USEFULNESS OF THE INVENTION

As explained previously, any thermoplastic article which is designed to contain contents which are susceptible to oxidation can benefit from the macromolecular, non-migrating, dendrimers functioning as oxygen scavengers which becomes a part of the article in its final form.

It is known that oxygen can react with flavors, dyestuffs, amino acids, vitamins, fatty acids, anti-oxidants (present for other purposes), and other sensitive organic chemicals. Oxygen can transform enzymes and promote the growth of any aerobic process including the propagation of yeast, mold, or bacteria.

Any food or beverage, medicament or cosmetic, or any other material highly reactive with oxygen molecules can benefit from this invention. Shelf life of food and other perishable materials can be extended because of the presence of the macromolecular reducing agent, preferably activated by a catalyst at an appropriate time.

### EXAMPLES

### Example 1 and Comparative Examples A-C

### Preparation of Compound Containing Dendrimers

Table 2 shows the ingredients and the formulations. reactive extrusion conditions in a Prism 16 mm 40 L/D parallel twin screw extruder.

TABLE 2

| Ingredients | A | B | 1 | C |
|---|---|---|---|---|
| Eastman 9921P Polyester | 98.96% | 99.46% | 98.46% | 100% |
| (PET) powder from | | | | |
| Eastman Chemicals | | | | |
| Boltorn W3000 | 1.00% | 0.50% | 1.00% | 0.00% |
| amphiphilic dendritic | | | | |
| polymer from Perstorp | | | | |
| Cobalt Hex-CAM catalyst | 0.04% | 0.04% | 0.04% | 0.00% |
| system from OMG Group | | | | |
| Joncryl ADR-4368-C | 0.00% | 0.00% | 0.50% | 0.00% |
| epoxy functional styrene- | | | | |
| acrylate oligomer from | | | | |
| BASF | | | | |

All Comparative Examples and Example 1 were melt-mixed in a Prism 16 mm 40 L/D parallel twin screw extruder, after manual pre-mixing ingredients, at a temperature of 250° C. and a rotation of 250. Even Comparative Example C underwent the same extrusion to establish completely comparative results. The extrusion produced pellets.

Films of Example 1 and Comparative Examples A-C were prepared by compression molding pellets of the samples between Teflon™-coated aluminum foil using a Carver model 3392 hydraulic press. For each film, the 3.0 gram of sample were first heated at 265° C. for 15 seconds and molded at 265° C. under pressure less than 1 ton for 30 seconds, followed by cooling in ice water bath. The resulting films were evaluated for transparency using Haze-Gard Plus purchased from BYK-Gardner and oxygen scavenging activity by DSC. Table 3 shows the results.

TABLE 3

| | A | B | 1 | C |
|---|---|---|---|---|
| Thickness (mm) | 0.18 | 0.18 | 0.26 | 0.22 |
| Transmission (%) | 84 | 86.2 | 84.7 | 87.4 |
| Haze (%) | 79.2 | 60.2 | 46.5 | 46.2 |

The haze differential between Example 1 (with both dendrimer and oligomer present) and Comparative Example C (with neither present) is a very small number, namely: 0.3, which is almost imperceptible to the human eye and near the limits of the testing equipment.

The comparison of haze between Comparative Example A and Example 1 is all the more revealing. That such a minor amount of oligomer (0.5%) is able to reduce haze by 32.7% was totally unexpected.

While not being limited to any particular theory, it is believed that the addition of the oligomer offers chemical reactivity with thermoplastic matrix and some type of physical interaction with the dendrimer. As such, the minor amount of oligomer can be considered to offer some type of compatibility between the thermoplastic matrix and the dendrimer which significantly reduces percentage haze to a level substantially the same as the haze of the thermoplastic matrix itself.

With clarity addressed, a Comparative Example and the Example were then examined using Differential Scanning calorimetry (DSC) to evaluate the performance of the dendrimer as an oxygen scavenger. According to ASTM D385-06, the test method consists of heating a sample to an elevated temperature, and once equilibrium is established, changing the surrounding atmosphere from nitrogen to oxygen. For Examples 1 and 3, 160° C. was chosen. The time from the first exposure to oxygen until the onset of oxidation is considered the Oxidation Induction Time (OIT). Specific OIT measurement procedures were as follows:

1) Calibrated the calorimeter instrument for heat flow, gas (O₂ & N₂) flow rate at 50 cc/min, and thermometer;

2) Weighed 7-10 mg of sample in small pieces (cut if needed)

3) Purged the sample in sample cell with N₂ at flow rate of 50 cc/min for 15 min

4) Heated the samples at heating rate of 20° C./min to the setting temperature in N₂ and record the heat flow

5) Held the temperature at the setting temperature for 10 min in N₂ and continued to record the heat flow

6) Switched from N₂ to O₂ at flow rate of 50 cm³/min

7) Held the samples at the setting point constantly in O₂ and continued to record the heat flow for 100 min

8) Collected data of initial oxidation time, peak oxidation time and peak area (oxidation efficiency/capability).

Table 4 shows the OIT results for Comparative Example A and Example 1.

TABLE 4
OIT at 160° C.

| | Start to | Peak | Peak Area |
|---|---|---|---|
| | oxidation, | oxidation | (Enthalpy), |
| Example | min | time, min | J/g |
| Comp. Ex. A | 2.4 | 3.99 | 13.58 |
| Ex. 1 | 2.39 | 3.0 | 14.85 |

The results of OIT demonstrated the addition of the oligomer did not disrupt the oxygen scavenging capability of the dendrimer in the thermoplastic matrix. The OIT results also showed both Comparative Example A and Example 1 to be excellent oxygen scavenging compounds because the onset of oxygen scavenging was rapid.

The invention is not limited to above embodiments. The claims follow.

1. A method for scavenging for oxygen within a thermoplastic article, comprising:
(a) mixing a reducing agent for oxygen molecules and an epoxy-functional styrene-acrylate oligomer into a thermoplastic polymer matrix to form a thermoplastic compound and (b) forming an article from the thermoplastic compound,
wherein the reducing agent is amphiphilic dendritic polymer having carbon-carbon double bonds susceptible to reaction with oxygen molecules, and wherein the thermoplastic compound has substantially the same percentage haze value as the thermoplastic matrix.

2. The method of claim 1, wherein step (a) also includes mixing a catalyst into the thermoplastic compound.

3. The method of claim 1, wherein the dendritic polymer comprises a dendritic globular structure from which chain ends are terminated by a combination of hydrophobic chains and hydrophilic chains.

4. The method of claim 3, wherein the hydrophobic chains are long unsaturated fatty acid chains.

5. The method of claim 3, wherein the epoxy-functional styrene-acrylate oligomer has a polydispersity index of from about 1.5 to about 5.

6. The method of claim 1 further comprising a functional additive selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

7. The method of claim 1, wherein the dendritic polymer reduces an oxygen molecule by reaction with a carbon-carbon double bond, thereby scavenging the oxygen molecule from the article.

8. A thermoplastic compound, comprising: (a) a thermoplastic polymer matrix; (b) an amphiphilic dendritic polymer having carbon-carbon double bonds susceptible to reaction with oxygen molecules; and (c) epoxy-functional styrene-acrylate oligomer.

9. The compound of claim 8, further comprising a catalyst for the dendritic polymer to function as a reducing agent for oxygen molecules.

10. The compound of claim 8, wherein the epoxy-functional styrene-acrylate oligomer is the polymerization product of (i) at least one epoxy-functional (meth)acrylic monomer; and (ii) at least one styrenic and/or (meth)acrylic monomer, wherein the polymerization product has an epoxy equivalent weight of from about 180 to about 2800, a number-average epoxy functionality (Efn) value of less than about 30, a weight-average epoxy functionality (Efw) value of up to about 140, and a number-average molecular weight (Mn) value of less than 6000.

11. The compound of claim 10, further comprising a functional additive selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

12. The compound of claim 1, wherein the dendritic polymer comprises from about 0.1 to about 3 percent by weight of the compound, and wherein the epoxy-functional styrene-acrylate oligomer comprises from about 0.1 to about 3 percent by weight of the compound.

13. A thermoplastic article, comprising the compound of claim 1.

14. The article of claim 13, wherein the article is a bottle pre-form.

15. The article of claim 13, wherein the article is a blow-molded bottle.

16. The article of claim 13, wherein the bottle contains a perishable food or beverage susceptible to oxidation.
